(19) United States
(12) Patent Application Publication
(10) Pub. No.: US 2006/0021642 A1
(43) Pub. Date: Feb. 2, 2006

(54) Apparatus and method for delivering acoustic energy through a liquid stream to a target object for disruptive surface cleaning or treating effects

(76) Inventors: John W. Sliwa JR., Los Altos, CA (US); Carol A. Tosaya, Los Altos, CA (US)

Correspondence Address: David W. Collins;Intellectual Property Law, Suite 125B, 75 Calle de las Tiendas, Green Valley, AZ, 85614, US

(21) Appl. No.: 11/193,958

(22) Filed: Jul. 28, 2005

Related U.S. Application Data
(60) Provisional application No. 60/592,593, filed on Jul. 30, 2004.

(51) Int. Cl. B08B 3/12; B08B 3/00

(52) U.S. Cl. 134/184; 134/1; 134/34

(57) ABSTRACT

A device and method are provided for delivering moderate to high power acoustic energy to a target object through one or more emitted streams of liquid for the purpose of altering at least the target surface. In an embodiment, the acoustic energy is provided by transducers acoustically coupled into the liquid stream(s) and the acoustic energy and liquid emission apertures are common and elongated. The user directs the apparatus such that the acoustically-transporting liquid stream impacts upon the surface to be altered. Cleaning surfaces is an example of an alteration process. Agents may be added to the liquid stream to enhance surface alteration processes.

### CROSS-REFERENCE TO RELATED APPLICATIONS

The present application claims priority from provisional application Ser. No. 60/592,593, filed Jul. 30, 2004.

### BACKGROUND OF THE INVENTION

1. Field of the Invention

The present invention relates to devices, systems, and processes using acoustic energy for cleaning or surface-alteration.

2. Description of Related Art

By far the most widely used systems utilizing acoustic energy for cleaning are immersion systems employing ultrasonic transducers. Items to be cleaned are immersed in a liquid filled tank, usually with a cleaning enhancing agent such as a solvent, detergent, wetting-agent or cavitation-agent added, and ultrasonic energy is transmitted into the liquid tank from at least one transducer mounted thereon. There are numerous commercially available systems that utilize this technology including ones made by Branson, Crest and many others. Typically, these systems operate in the 15-70 KiloHertz (KHz) range and most commonly in the 15-30 KHz frequency range at sufficient power to drive steady cavitation, which is known to serve as the primary energetic cleaning (or treating) mechanism. Such systems and their ultrasonic output are never used on human skin, as any such significant cavitation would cause skin damage of a mechanical and thermal nature as well as pain. On the other hand, such systems are frequently used on non-living inanimate mechanical, electronic and optical parts, components, materials etc., which are insensitive to limited or even unlimited cavitation. The point is that cavitation is the primary industrial acoustical cleaning or treating mechanism for inanimate surfaces, but it is not regarded as safe for human skin use as reflected by federal regulations of the Food And Drug Administration (FDA) in the United States. The skin is a very sensitive organ and is easily damaged by cavitation phenomenon even on its surface.

Another type of system using acoustic energy for cleaning excites a tip of a tool with sonic energy and the vibrating mechanical tip is placed in direct physical contact with the item to be cleaned. An example is tooth-cleaning devices that involve ultrasonic excitation of a tooth-contacting water-flushed tip. These are the ultrasonic descaling devices utilized by a dentist for cleaning teeth. They primarily cavitate plaque and other hard tooth coatings and are not aimed at gum tissues, which are very sensitive.

Hydraulically pressure-pulsed products with pulsatile water flow, such as tooth and gum cleaners found in many modern home bathrooms, are not sonic cleaning devices; they are pulsating flow devices wherein the flow velocity equals the pulse velocity. There is no significant acoustical energy delivered by these devices nor is there any cavitation occurring.

EP 00645987B1 to Harrel discloses a descaler utilizing an ultrasonically excited scraper tip and a liquid flush. EP 00649292B1 to Bock discloses an ultrasonically energized brush used in the direct contact mode. Both of these use the acoustics to attack tooth coatings and plaques. The scraper surely cavitates and the brush might cavitate under some conditions. Again, any significant cavitation-exposure of the gums would both be painful and damaging. Note that in the above devices, the acoustic cavitation, if any, is produced directly on or at the enamel tooth surface to be cleaned by a mechanical exciter physically deliverable to that surface.

We have cited these ultrasonic references first as they are cleaning references and cleaning is a major use for our invention herein. However, as will be seen, we deliver disruptive cleaning energy in a different manner.

There are systems which (transmit/receive or pulse/echo) couple very low bidirectional acoustic energy through a short liquid stream or film to an object for non-destructive testing (NDT), but these are very low-power mapping or imaging systems in which disrupting or cavitating the object to which the liquid stream is coupled is to be absolutely entirely avoided. Such NDT systems have been known for 30 years or more. These systems use sonic echoes to analyze the object and take great pains in their design and operation to avoid any disruptive action at all. They are not cleaning systems and in fact are used to detect rather than remove contaminants. An example of an acoustic NDT system that contemplates delivery of acoustic energy to a test site via a liquid stream is found in U.S. Pat. No. 4,507,969 to Djordjevic. Note that cavitation phenomenon, if allowed, would not only damage the workpiece but also introduce unwanted acoustic harmonics into the received echo signals. NDT imaging is therefore done at acoustic power levels far lower than that required to cavitate. Generally, such NDT systems use as short a coupling water plume as possible, as every surface ripple and bubble in the plume introduce acoustic confounding noise to the NDT process. Typically, such gravity-fed plumes are a fraction of an inch to a couple of inches long maximum and utilize essentially pure water to minimize attenuation and bubble content. Pressurized water is not used, as flow rate needs only be high enough to assure coupling and it is normally desired that the coupling water be conserved and not have to be cleaned up.

There is also a system disclosed in U.S. Pat. No. 5,013,241 to Von Guffield, which claims to utilize an ultrasonically energized liquid stream to clean a tooth upon which the stream was blindly directed by a user. This device was neither clinically nor commercially successful because the design of the device ignored prior art that teaches that powers of even a few watts/cm² cause severe pain and undesirable sensations (as well as cellular damage) to the sensitive gums in real human applications. No cleaning agents were disclosed by Von Guffield as being necessary or desirable for adding to the liquid stream. Also, the Von Guffield ultrasonic transducer was not liquid cooled nor air-backed, thus limiting the power level and efficiency at which it could operate. The Von Guffield disclosure did not teach the use of high power ultrasonic energy and in fact tried to keep the energy low enough to avoid admitted discomfort, which also meant that the cleaning action was rendered relatively ineffective. Had Von Guffield used high power in the range contemplated by the device disclosed and claimed in the instant application, Von Guffield's transducer would have overheated and failed, as well as caused severe disabling pain and serious gum damage to the patient due to cavitation. The Von Guffield device cannot merely be scaled up or used in multiple numbers to anticipate the device disclosed and claimed in the instant application. It would not produce the result that the instant invention accomplishes, which is the rapid cleaning of objects over a relatively large area of their surface (or subsurface, interstices etc if permeable). The instant invention most preferably accomplishes this result by using an elongated energy generator that couples high-powered acoustic energy into a liquid stream(s) that is(are) directable onto an object to be cleaned. Liquid cooling of the acoustic energy source and the use of additive cleaning-enhancing or other surface-alteration agents are desirable for high efficiency operation and are not disclosed by Von Guffield. Furthermore, multi-step processes such as cleaning and rinsing are also not therein disclosed or suggested. Immersion systems do not use flowing-liquid transducer cooling and none have contemplated their use in connection with a liquid stream that is delivering substantial acoustic cleaning energy to a distant non-immersed object. Immersion systems are effective for cleaning items that can be put into their tanks, but impractical for on-site field cleaning of large objects that cannot be easily moved into or even fit into a tank. The Von Guffield device was designed for spot cleaning of live teeth in situ and cannot deliver sufficient power or a large enough acoustically energized liquid stream for effective use in industrial-type cleaning. The very fact that no commercial versions of the Von Guffield invention have ever been made, despite its desirability, argues against its obviousness. There is no limit to the size of an object that can be cleaned by the instant invention, yet the prior art deals with large objects by making larger and larger immersion tanks. Pressure washers of the type that typically use piston or diaphragm pumps to deliver water blast cleaning through a nozzle at pressures upwards of 1000 psi are useful, but not nearly as effective as the instant invention, which can actually clean any portion of an object that the acoustically energized liquid can contact, including backsides, interstices, and other areas that are treated far less effectively by mere pressure blasts directed from a distal point. High-pressure jet washers do not utilize ultrasonics and thus are still subject to fluid boundary-thickness effects.

Additional patent references are included below. These provide detailed disclosures as to how ultrasound or ultrasonically produced bubbles or added bubbles can be used to enhance the cleaning of objects in immersion tanks.

U.S. Pat. No. 5,156,687 to Ushio teaches ultrasonic wet-surface pretreatments for the painting of polymers. U.S. Pat. No. 5,143,750 to Yamagata teaches oxidation removal and polishing of work surfaces using ultrasonic wet processes. EP 01036889A1 to Shinbara teaches bubble-loading of liquids to enhance cleaning in the presence of ultrasonics. Neither of these teaches or suggests water-jet or plume delivered high-energy ultrasound for cleaning or treating.

Finally, we have a class of devices in the prior art designed to deliver medical therapies to subdermal tissues or organs in living beings. The authors have developed products in this arena of therapeutic or surgical ultrasound. Frequently seen such applications include the acousto-thermal ablation of cancerous tissues. If cavitation is also or instead employed, it is because mechanical tissue destruction is desired. Such destruction, given the presence of cavitation, is unavoidable both on the macroscopic scale and on the microscopic cellular or genetic scale. So we again emphasize that the delivery of cavitation ultrasound to surface tissues is not practiced if one desires to avoid damage.

U.S. Pat. No. 6,450,979 B1 to Miwa teaches the ultrasonic exposure of subdermal fat cells in a human body for the purpose of depletion of their adipocytes fat-content. Note how carefully Miwa focuses, properly so, on avoiding cavitation in the patient. Note also how carefully Miwa avoids any significant heating (by any mechanism) of the patient's tissues. The point to be taken here is that Miwa's treatment, in industrial terms, is a very-low power ultrasound treatment as well as a non-cavitation treatment unlike virtually all industrial treatments and is not useful as an industrial treatment.

Thus, when Miwa suggests passing his therapeutic ultrasonic energy through a water stream or array of water jets (FIG. 8, for example) along the lines of the already-mentioned prior art above, it is low power non-cavitating ultrasonic energy below the cavitation (and heating) thresholds he defines. The passage of such low power or non-cavitating ultrasound through a water stream is not at all new and has been practiced for decades in the use of water-plume coupled NDT (non-destructive testing) transducers as mentioned above. The Miwa patent claims the implementation of the acoustic obesity treatment in certain frequency and acoustic-power ranges, which have patient-acceptable hemolysis limits, cavitation limits and thermal-index limits. Industrial ultrasonic cavitation processes are purposely arranged to operate under conditions that violate some or all of these three limiting Miwa operational conditions or no useful cavitation-induced cleaning or treatment would occur in the immersion tank. Thus, the Miwa work would lead one away from the instant invention.

Further, we note explicitly in Miwa's apparatus, such as that in FIG. 8, that he has not accounted for the fact that a transducer emitting ultrasonic energy toward an aperture plate (his FIG. 8, items 5 and aperture plate with holes 31) will cause large acoustic reflections and diffractions as the leftward moving acoustic waves impinge upon his aperture plate between holes 31 and around holes 31. This results in acoustic interference, acoustic misdirection, and large acoustic non-uniformities in acoustics emanating from some or all of the orifices. What is needed, and not taught, is a means to assure that any ultrasound not emanating from an orifice 31 such as that impinging between the holes 31, does not cause a problem. Further, assuming one did crank up the acoustic power of the Miwa showerhead, one would also get acoustic cavitation inside the showerhead and behind the orifices, a location that would allow for transducer damage as well as orifice erosion.

So the prior art fails to teach a means to deliver high-power acoustical cleaning or treating energy through a liquid stream in a manner wherein: a) the transducer is not thermally damaged, b) wherein interfering reflections do not degrade the passing acoustical energy, c) wherein cavitation in the streaming device damages the streaming device and its orifice(s), d) wherein acoustical cavitation can be driven at a distal location along the stream (if it is desired), or e) wherein cavitation, treatment or cleaning agents are delivered into or to the stream. Further, none of the prior art teaches the use of f) acoustical echoes passed along such a stream to monitor or assess a parameter such as attenuation, detergent-content or a workpiece-distance for such a cleaning or treating process. Finally, none of the prior art teaches g) the manipulation of the shape of the stream(s) or jet(s) to enhance acoustical waveguiding or acoustical amplification phenomenon such that distal cavitation can be accomplished.

The instant invention preferably utilizes extended (fractions of a meter or at least several centimeters) laterally-extended plumes or films of liquid or utilizes arrays of smaller streams with overlapping treating action that have not been suggested by the above art and that would cause severe multi-path signal propagation problems for the prior NDT art. The prior art low-flow approach would not allow for a meter-length plume to be formed at any significant angle to gravity or the vertical using water. We also have discovered that separate adjacent impacting plumes or streams can provide a work surface interstream cleaning effect due to acoustic propagation laterally on the work surface within the liquid meniscus between impinging streams, something not disclosed or suggested by the prior art. Our optional use of bubbling or bubble constituents in a flowing jet of liquid intended to deliver acoustic energy to a workpiece is counter-intuitive. We find that low to moderate amounts of bubble volumetric percentage makeup in the plume add more stable and/or transient cavitation acoustics action than they cost in terms of increased attenuation. At some point a high enough (suds-like) concentration of bubbles will deliver virtually no acoustic cleaning action. Thus, there is an optimal middle ground. Furthermore, even non-bubbling additives increase attenuation, but we again realize that the added detergent effects outweigh the attenuation effects at least for low to moderate concentrations. These are counter-intuitive from the acoustics-manipulation point of view.

Because we can operate at moderate to high power (because of our unique preferred transducer liquid cooling and efficiency-enhancing air-backing and matching layer(s) of our transducers) and we can also optionally get additional beneficial stable and/or transient cavitation effects from modest levels of bubbles, we can afford to lose some acoustic energy to attenuation losses in the plume. So we can tolerate a variable-shaped plume and even plumes containing surface-ripples, defects and turbulence, if necessary. The toleration of turbulence or undulating surface shapes in a liquid waveguide is totally contrary to all the prior art. In NDT it introduces chaotic signal noise thus very very low flow laminar streams are utilized in NDT. In dental applications, it would involve very high flows introducing further considerable uncomfortable sensations and mouth flooding even with oral aspiration. In general, we utilize a somewhat acoustically lossy flowing waveguide contrary to all prior NDT and dental teaching.

Thus, a need exists for a system and method for an acoustically enhanced liquid cleaning or treating approach that does not depend upon immersion of the object to be cleaned and can utilize multi-component liquids, workpiece-local cavitation as desired, and medium to high-power without transducer overheating. There is also a need for a system that can effectively clean in shielded or obstructed areas where the cleaning effect of high velocity liquid blasts is decreased. It is also desirable that such a system be capable of being used in hand held or fixed mount devices and which also can be automatically or manually directed towards objects to be cleaned.

### BRIEF SUMMARY OF THE INVENTION

The present invention combines a liquid cooled, preferably elongated, acoustic energy source capable of moderate to high power operation, a liquid stream(s) into which acoustic energy is coupled with the stream(s) being directable onto and or into a target object for delivering acoustic cleaning energy and associated liquids thereto. The acoustic energy source is preferably air-backed and acoustically impedance matched with a matching layer, such that the treating or cleaning acoustic energy is efficiently propagated forward toward the workpiece.

In one embodiment of the invention the system includes a hand held device with an extended row of ultrasonic transducers arranged to couple ultrasonic energy into a liquid stream which also cools the transducers and is user directed towards the object to be cleaned. By using the transducer heated liquid for at least a portion of the liquid stream carrying the acoustic energy to the object to be cleaned, the cleaning action may be somewhat enhanced by the additional thermal energy imparted to the liquid by the transducers. Such waste heat can be conducted from the transducers, directly or indirectly, or be delivered to the fluid stream by acoustic attenuation in the fluid. Heaters can be also employed in various configurations to further heat the liquid that carries the acoustic energy. In further embodiments the system includes apparatus for filtering and recycling the liquid from the stream, enhancing the cleaning effectiveness by delivering an enhancing agent or additive to the cleaning site, fixed mount and directable turret mounted devices, and multi-step operation which can include clean rinse and drying cycles or even ultrasonically-enhanced surface-alteration processes such as polishing, stripping or priming. We note that cleaning is herein being discussed in the most detail as just one type of surface-alteration process for which the inventive device is applicable. We again stress that the addition of agents or additives such as soaps, detergents, cavitation-manipulators, etc. to the water plume is counter-intuitive as it increases attenuation. However, the added cleaning or treating benefit more than makes up for the acoustic attenuation. We explicitly note that our inventive apparatus may utilize such additives or agents which are introduced at any point or at any time including a) premixing with the plume liquid, b) injection into the plume or c) predeposition or simultaneous deposition on the worksurface perhaps by other deposition methods or means such as a spray or dip.

Still further embodiments can emit discrete “chunks” of acoustically energized liquid that, although no longer directly coupled to the acoustic energy source through a continuous liquid stream, still carry within their moving volume internally propagating and reflecting acoustic energy to an object to be cleaned. Such an embodiment would likely utilize a high near-sonic, sonic or supersonic plume flow rate such that the ultrasonic energy in the water “packets” is not fully attenuated by the time the water plume packet impacts the workpiece. Another embodiment can introduce bubbles into the liquid stream or allow for bubble formation in the stream for enhancing cleaning action. In particular, this will best promote stable cavitation events as opposed to transient cavitation events.

### BRIEF DESCRIPTION OF THE DRAWINGS

FIG. 1 shows a system of the present invention delivering acoustic energy to an object to be cleaned through a liquid stream in accordance with an embodiment of the present invention.

FIG. 2 shows an alternative embodiment of the system of the present invention in which discrete acoustically energized liquid streams are directed onto an object to be cleaned.

### DETAILED DESCRIPTION OF THE INVENTION

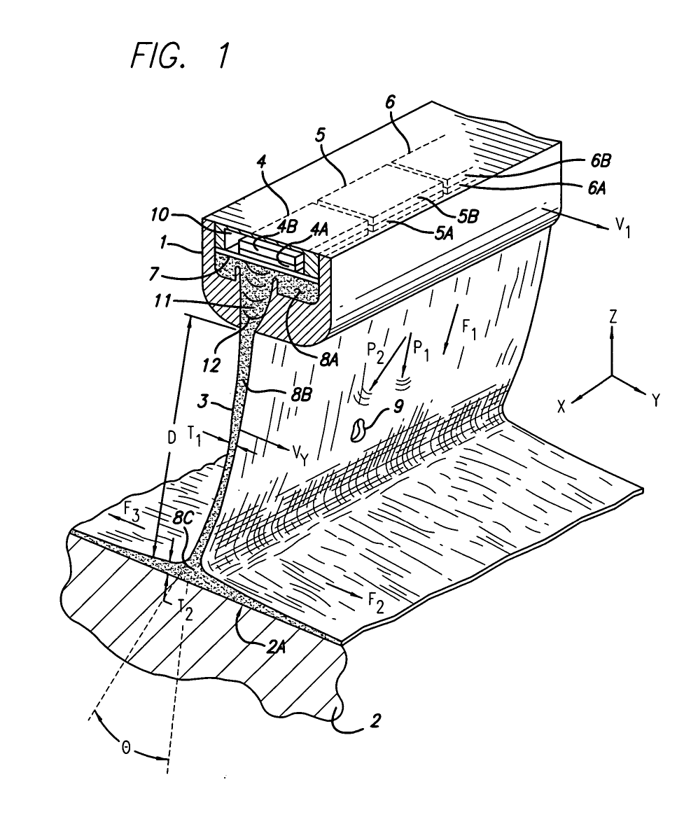

FIG. 1 shows in cross section an embodiment of a system of the present invention. A cleaning wand 1, which may be manually directed or directed through any number of mechanical, hydraulic, pneumatic, electromechanical or other steering means, is shown as being elongated or extended in the X-axis. The wand includes an elongated row of ultrasonic transducers of which the first transducer in the row is shown as 4 with its respective piezo electric element 4B, which produces acoustic energy when electrically excited. Transducers may be of any type including piezoceramic, electrostrictive, magnetostrictive, electromagnetic, ferroelectric, electrostatic or MEMs-based such as CMUTs (capacitive micromechanical ultrasonic transducers), photoacoustic or any other known transducer types. The transducer(s) is(are) preferably air-backed and, at least partly, liquid cooled by the passing plume liquid. Item 4A is an acoustic matching layer for transducer piezomaterial 4 and serves to optimize the acoustic coupling of acoustic energy from the transducer piezomaterial 4B to the liquid 8A, which is on the other side of the liquid-isolation membrane 7 which serves to isolate the transducers 4, 5, 6 from the liquid 8A and any associated additives or agents therein. The liquid 8A preferably flows along a distribution manifold (shown generally running along the ±X-axis) and exits as a liquid 8B forming a film-sheet or stream 3 as it exits from the orifice 11. Orifice 11 is showed as tapered in shape, which has the effect of amplifying the acoustic pressure waves P1 that propagate generally downwards (−Z-axis) towards a work substrate 2 with a dirty surface 2A. Explicitly noted at this point is that our acoustic energy directed into the plume may be in the form of blanket energy or focused energy, and the focus may even be moved within the confines of the plume as by operating the transducers 4, 5, 6, etc. as a phased array. This also allows for exceeding the cavitation threshold outside the head 1. Our orifice 11 may be in the form of a single continuous slit (shown in FIG. 1) or in the form of juxtaposed but separate slits or holes (not shown in FIG. 1). One or more rows of slots or holes or a random array of slots or holes 11 may alternatively be utilized. In the case of separate slits or holes, we can optionally arrange for the individual jets or plumes to combine soon after exit to form a continuous plume (if desired). Within the scope of our invention is any orifice or aperture 11 shape or pattern including the orifice 11 comprising a porous material or an array of size-adjustable apertures. We note that appropriate acoustic antireflection measures may be taken in the manifold and behind-orifice regions to avoid undesired multiple reflections or diffractions. Such measures could include, for example, the disposition of absorbing films (not shown), or the disposition of highly scattering surfaces (not shown) or the focusing or directivity of the transducer(s) 4A/4B mainly (shown) or only into the plume(s) 3.

The pressure waves P₁ (vertically directed) and/or P₂ (angularly directed) from the transducers are coupled into the liquid plume 3 through acoustically-transparent membrane 7. Membrane 7 could, for example, be a very thin stainless steel foil or a copper-foil that would have acceptably low losses, a hermetic nature, and serve as a ground electrode if desired. Transducers 5 and 6 are the second and third transducers (with piezo electric elements 5B and 6B respectively) in the extended row and are coupled to the liquid through their respective matching layers 5A and 6A and membrane 7. The acoustics oriented reader will realize that the membrane may also be sandwiched between the matching layers and PZT exciters (not shown) or one may even utilize the membrane material itself as a matching layer. Further, one may sacrifice coupling efficiency and omit the matching layer. Item 8C is the deformed liquid stream 3 as it impacts the surface 2A to be cleaned or otherwise treated or altered. Item 9 illustrates a transient defect (hole) in the otherwise substantially continuous film or stream 3. Transient defects such as hole 9 do not substantially impact the effectiveness of the cleaning as the acoustic energy from at least one transducer will propagate around the defect and the acoustic shadow of the defect will likely move in the X-axis as well. In fact, the present inventors include an embodiment wherein controlled bubbles or microbubbles are purposefully formed in or injected into the plume to serve as cavitation sites. In some cases, injected additives or agents, even of a solid nature, may serve as cavitation nuclei. An air cavity or “air-backing” 10 is shown surrounding the backs of transducers 4, 5, and 6 in the array. The use of air on the backside of the transducers minimizes backwards acoustic propagation, thus enhancing the efficiency of selectively delivering acoustic energy in the forward direction of the liquid. However, this makes liquid cooling of the transducer using the plume liquid highly desirable. The pressure waves formed by the interaction of the transducers and the liquid that flows past them produces pressure waves 12 shown in vector-format as P_{1 and P}₂ in the film 3. F₁ is the liquid flow vector in the downwards-moving film of liquid 3. F₂ and F₃ illustrate the split lateral flow vectors of F₁ after it impacts the surface 2A and is typically redirected. P₂ illustrates pressure waves angled downwards in the X- and Z-axes as by phase-delayed firing of two transducers 5 and 6 (beam-forming) or as by angled propagation from a single transducer 4, 5 or 6. V₁ is the translational velocity (if any) of the wand 1 in the Y-axis and V_{Y} is the velocity of the film 3 in the Y-axis. T₁ is a local thickness of free film 3. T₂ is a local thickness of the film on surface 2A near the point of impact. D is the approximate film length or working-distance in the Z-axis and we specifically note that because the film 3 curves to an angle theta (θ), that the actual curved film 3 length is somewhat longer than D. Theta is the angle of film impact (shown to be about 20 to 30 degrees in FIG. 1. The plane of the film 3 is shown generally in the X-Z plane with the wand velocity V, in the Y-direction (mutually orthogonal). In the most general case, V₁ and/or V_{Y} may have an angle to the film plane and the wand may also have rotational or twisting components as well as D, T₁, T₂ and theta, F₁, P₁ and P₂ variations as it is used. Acoustic waves emanating generally downwards through film 3 of average thickness T₁ will undergo reflection, refraction and mode conversion upon impacting the surface 2A and/or upon interacting with turbulence, ripples, bubbles or shape-variations in the surface (or volume) of film 3 (such variations not shown). At any instant, V₁ may be different from V_{Y} due to accelerations and twisting. The shown curved shape of film 3 is from wand movement and/or gravity and would likely be vertical and straight as emitted from a static wand emitting straight downwards. The wand 1 can be manually moved or moved by any mechanical means. It may even be used as a subsystem component in a larger machine such as a car-wash. Alternatively, or in addition, the work article 2 may be moved. In simple form the wand 1 can have a number of ultrasonic transducers such as 4, 5, 6 . . . , which are fired individually, one at a time, or in pairs or other multiples, and whose firing can be “walked” up and down the row. In more sophisticated versions, they could be operated as a phase-gated array for the purpose of electronic beam steering within the confines of one or more plumes. Also, by moving the plume itself, as by scanning it, it will effectively move the entrapped acoustic energy with it. The acoustician will realize that acoustic beam-forming and aperture-control schemes typically applied to medical ultrasound imaging or sonar could be utilized here. The heating of the liquid which is provided by the transducers' heat is likely to be slight, typically a few degrees C. or less. If a high temperature liquid is desired for enhanced cleaning or treating, then heaters can be added to the system. Such heaters, pumps, etc. could be located in the wand itself, or more preferably located in a supportive control or utility box (not shown) which can lay on the ground, be mounted in a backpack, or at least not have to be hand-held.

Typical additives (agents) to liquids used would include items such as detergents, soaps, emulsifiers, solvents, surfactants, antimicrobials, sterilants, wetting agents, surface-tension adjusters, pH adjusters, bubbles or bubbling particulates as cavitation agents, etchants, passivations or other workpiece coatings. They could also include insecticides, antifungicides, antibacterials, antivirals, oxidizers such as hydrogen peroxide, antiseptics, chemical etchants, primers, paints, polishes, waxes, ultraviolet barriers, sealants, stains, other decorative finishes or even abrasives. Additives may act on their own or may react with other additives or with the workpiece surface being treated. Water will be the typical plume liquid utilized and that water may be preconditioned as by heating, cooling, additive mixing, degassing, gasifying, water-softening or filtering. The plume liquid(s) or additives may also be recirculated or refiltered. Additives can be introduced directly into the acoustically energized liquid film 3 at any number of points before impact or in an alternative approach they could be delivered to the surface 2A from a different source or delivered separately to mix with the acoustically energized liquid. We note that in some applications water may not be used and instead a solvent, for example, is used. Alternatively, the wand 1 may emit nothing but the “additive” or agent with no dilution or buffering. We simply note that water is expected to be a common base-liquid or sole emitted liquid, as it is inexpensive and readily available.

By delivering the acoustically energized liquid in discrete and separated volumes (“chunks”) (not shown) further enhanced cleaning action and/or conservation of dispensed liquids or additives may be obtained. Even though the chunks or stream-segments are not directly coupled to the transducers, once they leave or detach from the orifice 11 (non-bridging, at least temporarily), they still contain internally propagating and reflecting acoustic pressure waves which, if they reach the surface 2A before their energy has decayed or attenuated too far, can deliver enough energy to the surface to perform a useful cleaning (or treating) action. In cleaning of contamination that has resilient components, sometimes a period of time without liquid impact will allow a spring-back action to occur, which will place certain previously bent-over contaminants in a better position or attitude for cleaning by the impact of a subsequently delivered acoustically energized liquid chunk or “packet”. Furthermore, the impact of each separate stream-segment involves more disruptive energy than an equivalent unbroken single segment. Pulsatile continuous flow (pressure-varying wherein the pressure waves travel approximately at the stream velocity) may be even better for this situation, since it permits a direct coupling of the transducers to the liquid during the entire transit from the orifice 11 to the surface 2A and even beyond that point. It is a simple matter to produce chunks or pulsatile continuous flow liquid using pumps, electrically controllable valves or many other well known techniques.

The device of the instant invention can be used in multi-step operations where wash and rinse cycles are used or an active or passive drying cycle is introduced. The liquid (and/or additives or agents if any) may be filtered and or recirculated and can be alternately applied to the surface 2A with and without acoustic energy coupled into it. The taper of orifice 11 causes an amplification effect that is sometimes beneficial but is not essential to the operation of the device. We note further in FIG. 1 that the plume or stream 3 is itself tapered to be narrower at the workpiece 2 than at the wand 1 such that acoustic amplification will take place in the stream in the known geometry-derived manner of acoustic horns. Such tapering or other beneficial shape control of the plume(s) may be implemented in any manner including via: a) known surface tension effects, b) passage of the plume through a flowing gas or in proximity to a flowing gas jet or duct, c) electrostatic effects when using a conductive liquid, d) magnetic effects when using a magnetized liquid, e) thermal gradients affecting surface tensions, f) thermal gradients affecting viscosity, g) temporary thickening of the plume locally at the exit orifice as by, for example, spinning of the orifice head, h) drag effects, i) the effect of acoustics being pumped into the plume or j) an effect of additives or bubbles

Multi-step cleaning or treating processes are contemplated herein such as:
a) clean and rinse, optionally dry;
b) clean, rinse, optionally dry and apply seal (coating);
c) cavitationally abrade and rinse, optionally dry;
d) cavitationally abrade, rinse, optionally dry and apply seal (coating);
e) etch (chemically/acoustically), rinse, dry and prime (coat);
f) etch (chemically/acoustically), rinse, dry, prime (coat) and paint (coat) or just etch/paint;
g) etch, rinse, dry, prime (drying using flowed gas, for example, or a water dissolving solvent);
h) cavitationally abrade and rinse (without grit, replace sandblasting, for example);
i) wash and optionally polish (autos, trucks, trains, planes)
j) degrease and rinse, optionally dry; and
k) strip paint, wash, rinse and optionally dry.

Operation of the device of the present invention is relatively straight forward. Transducer excitation mode is preferably CW (continuous wave) or CW pulsed and can employ swept frequencies or multiple or single discrete frequencies and/or harmonics thereof as is known in the acoustic arts. We can emit single or multiple different frequencies or even broadband from a given transducer or from neighboring transducers, and these frequencies can be mixed and even beam-formed using phased array techniques known to the acoustic arts. One may also or instead use wave-shaping or wave-biasing in known-art manners to suppress or enhance cavitation (acoustical formation of bubbles) if that is desired. We utilize, optionally, one or both of stable cavitation and transient cavitation wherein we enhance cavitation for some processes. Stable cavitation typically involves bubbles that oscillate between finite non-zero sizes. Such oscillation requires little acoustic energy given a seed-bubble is provided in the form of a microbubble or dissolved gas that precipitates out of solution. Transient cavitation involves total cyclic collapse of the bubble and is a process requiring large acoustic input energy as the bubble is ripped from solid fluid every wave-cycle. Such cavitation can also cause physical erosion or pitting or the workpiece if desired. Transient bubbles require no seeding at all, although surface-tension reducing agents, dissolved gases, and injected microbubbles, for example, enhance the known effect. However, such transient cavitation is energy-consuming and can be damaging to a workpiece or painful to a human subject. Such surface damage may be part of a useful surface-process such as abrasion or physiochemical etching. When stable or transient cavitation occurs, some bubbles are acoustically excited into oscillation wherein micro-streaming flow occurs around the bubble periphery, thus enhancing the cleaning action of the liquid stream particularly adjacent the work surfaces where such bubbles tend to loiter. Again, these are acoustically-known cavitation effects. Within the scope of the invention is certainly the formation and/or delivery of cavitation bubbles to the workpiece to enhance our inventive cleaning and treating processes. However, we further include in that scope that such cavitation bubbles or nuclei therefore may be formed or injected at any point before workpiece arrival, such as in the plume or in the apparatus head itself. We anticipate that for the higher plume flow velocities that a single cavitation event will take place over a physical traveled distance in the plume and it is thus possible to have cavitation events begin in the plume before finishing (imploding) at or within useful range of the workpiece.

The operative liquid, for example water, is preferably cleansed of particulates, carbonates, solids and other filterable or easily extractable contaminants with an accompanying filter or known filtration-bed means, which may be disposable. Contaminants that can be removed by chemical treatment can be treated by chemical processors that are incorporated as a part of the liquid treatment subsystem. The direction of acoustic waves, such as P₂ and P₁, may be determined by operating the multiplicity of transducers as a phased array (steering) or by orienting the transducers or using concave or other specially shaped transducers or other known means of focusing (mechanical focusing not depicted), steering or shaping acoustic wavefronts. Although not normally needed in a prior art general industrial cleaning operation, one or more transducers may be utilized herein in pulse-echo configuration to deduce parameters of interest such as dimensions and/or shapes and/or attenuation of plume 3. PZT transducers can be used to alternately “transmit” or “listen”, as is well known. Included in the scope of our invention is the use of pulse-echo or CW-CW echo techniques, for example, wherein ultrasound passed down the beam is passed again up the beam. Also included in the scope of our invention is the passive detection of cavitation anywhere that is desired. For a pulse-echo approach, at least some reflected acoustic energy can be sensed coming back up a continuous film or stream 3 for at least one of the purposes of: sensing the degree of film or stream continuity or attenuation, flow-velocity, additive-content, sensing of a tool to work-surface distance, sensing of a velocity of an effluent of the tool, or sensing an angle of impingement of a film or stream upon a work-surface. These functions can be performed by circuits, sensors, methods and algorithms well known in the acoustic arts.

Fluid or flowable-media (liquids, gases etc.) manifolds such as 8A may deliver water, detergents, wetting agents, surface-tension controlling agents, gas or vapor bubbles, micro bubble media, solvents or any agent that can enhance a desired surface alteration (or coating) operation such as cleaning, abrading, conversion, etching, priming, polishing or even drying. We include in the scope of the invention the practice of electrochemical conversion such as anodization wherein an electrode and current path may be utilized, perhaps using an electrolyte as the plume fluid. The operation of wand 1 may alternate between wash, rinse or dry and can optionally be arranged to deliver air, even heated air, through the orifice 11 to enhance drying. Included in the scope of the invention is the use of orifice 11 or additional coaligned or nearby orifices or nozzles to also deliver gaseous or vapor materials which do not necessarily carry acoustic energy for those cleaning or treatment steps. Chunks of non-bridging plume film (not shown) or isolated substreams (isolated from one or both of the wand or work surface at at least one point in time) may be used instead of a continuously bridging film as shown in FIG. 1. If liquid chunks or “packets” are used, chunk transit time across gap D is set to be on the order of or less than the acoustic decay time if the chunks are to be effective as acoustic energy carriers. In other words an acoustically excited liquid chunk impacts the work surface while it still has useful residual acoustic energy therein ringing about, as yet unattenuated. Plume chunks may take any shape, including, but not limited to, droplets, streams, and threads. The most desirable chunks are elongated in the flow F₁ direction as they offer more lower-frequency resonant modes having lower attenuation, thus more resonant total energy and a slower decay time. The working distance D may vary from very small (just big enough to avoid collision with workpiece 2) to quite large (on the order of fractions of a meter to meters) as long as an average low-defect path can be maintained. In general, higher viscosity and low surface tension liquids will be particularly adept at this but any liquid, such as water, will allow formation of unbroken plumes of useful utility. The liquid into which acoustic energy is coupled may be heated and/or cooled. The liquid may be a solution, a mixture, an emulsion, a paste or cream, a gel or any other flowable material regardless of how many phases it has. We emphasize that flow may be very slow as for a viscous liquid falling primarily under the influence of gravity (e.g., mm/sec) and may be very high such as for the high pressure supersonic flow of water. At low velocities and higher viscosities, the ultrasonic energy will actually stream (pump) the flow significantly. Flowed constituents may purposely change phase or react with each other or with the workpiece 2/2A in support of a surface process performed by the wand 1. Typically, the emitted flowable media will comprise water with some consumable additives. Film 3 typically impacts surface 2A at angle theta (θ) shown in FIG. 1. Angle theta will affect acoustic propagation amount and type in +Y and −Y directions. We note that with appropriate angle theta of impingement combined with gravity orientation, for example, could provide a wetting impacting meniscus that flows primarily or only in one direction-downwards for example (not depicted). Film 3 may have a flow velocity (parallel to flow direction F₁) as high as an appreciable fraction of the sonic velocity such as for a high-pressure ultrasound-assisted cleaning wand, or as low as required to just prevent uncontrolled breakup. Emanated acoustics may be manipulated to acoustomechanically suppress film breakup using streaming pressures to benefit and extend working distance. A preferably wand-based trigger or switch may be used to activate acoustics and or liquid additives. As a matter of safety and for regulatory compliance, the user will be electrically isolated by known UL approved isolation precautionary measures such as isolation transformers and known electrical-isolation double-stage protection schemes. We again note specifically that flow F₁, depending on angles of the wand and the workpiece vs. gravity, might result in a redirected flow of only F₂ or only F₃. This might be quite useful wherein recontamination of the workpiece is to be avoided. We have shown a typical case wherein the flow is bidirectionally split.

Film (flowable media) 3 may comprise a slurry formed of materials such as ice particles, microballoons, beads or other particles or extended molecules. The additive or filler material might even be reusable. The wand 1 may be oscillated or stepped, rotated or twisted. The work substrate 2 may instead or also be translated/rotated. The overall dimension of wand 1 may be from micromechanical (micron-sized) to meters if not tens of meters. The operative frequency may be beneficially chosen or dynamically controlled to have a controlled ratio to a dimension such as T or D and may be of the frequencies normally used in commercially available immersion ultrasound cleaning tanks. Relating an operational frequency to a dimension for acoustic propagation, resonance or amplification purposes is widely known in the acoustic art. Waveguides are known in the art to operate best when the propagating wavelength(s) have certain preferable known ratios to the waveguide cross-section in particular, as well as to the length. Flow F₁ is preferably at least partly laminar but turbulent flows F₁ which have low average duty-cycle (transient) propagation-path defects (e.g., defect 9) are also useable in our device because we do not care if the acoustic attributes of the shape-varying jet 3 cause some active or passive acoustic noise or transient masking. Still, on average, despite transient defects 9 and jet 3 shape-changes, we deliver high enough average acoustic power. The wand 1 performs a disruptive process upon the substrate 2 and changes the substrate in some manner as opposed to the NDT systems, which strive to avoid any disruption or change in the object to which the acoustically energized liquid is directed. The emanated liquid/mixture/solution (or constituent thereof may or may not have a constituent that remains with the substrate 2. For example, if the process is a coating process, then some part of the emanated material would either be deposited permanently or would cause a surface-conversion process to take place (e.g., etching or wax-coating).

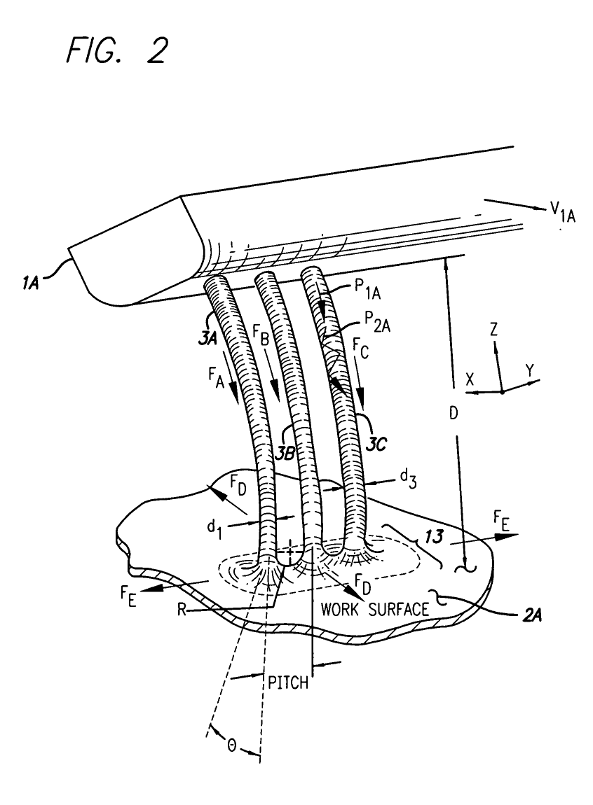

FIG. 2 shows an embodiment of the present invention that performs cleaning of a work surface 2A by deploying a multiplicity of individual separated acoustically energized liquid streams. FIG. 2 depicts the second mode of plume anticipated, namely that of a plume stream-array as opposed to the plume film of FIG. 1. Pictured is a cleaning wand 1A having three shown circular cross-section jets being ejected upon a surface 2A. The three jets 3A, 3B and 3C have individual flow rates F_{A}, F_{B}, and F_{C} respectively as well as respective average diameters of d₁, d₂, and d₃. For the sake of the example, all flow rates are equal and all stream diameters are equal. In this example, we have (not shown) transducer means inside of wand 1A directing ultrasonic energy into each plume or stream 3A-3C. Such directing could be, for example, by three separate transducers or by one common elongated transducer. It was realized by inventors that when the three streams impact in region 13 upon the surface 2A (sometimes referred to a “work surface”) that ultrasonic energy (as well as fluidic flow kinetic energy) is redirected to fill the interplume gaps shown having a wetted meniscus radius R. So we have downward flows F_{A}, F_{B}, F_{C} combining and causing work surface flows of the types F_{D} and F_{E} shown. Thereby originally downwards directed acoustic energy can be, at least in part, redirected laterally or into the surface 2A itself. This allows us to “alter” a surface 2A area larger and more contiguous than the isolated gapped impinging streams 3A, 3B, 3C would seem to support. Again note that each of or any of the streams 3A, 3B, 3C could be tapered to cause acoustic amplification (not shown).

The inventors have found that as long as the pitch (spacing) of the adjacent plumes is not hugely greater than the plume diameter d1, then effective cleaning can be achieved even between plumes due to the meniscus of radius R that wells around the plume impact points and the above lateral acoustic propagation in that meniscus. This welled wetted (non-zero thickness) mound is capable of passing ultrasonic energy within itself such that all wetted regions of the work surface at least in the wetted region 13 are effectively cleaned. Within plume 3C, we further depict ultrasonic waves passing straight down the plume as P_{1A} as well as additional or alternative waves P_{2A} passing along that plume via some reflections from the plumes water/air boundary. Passing waves may or may not undergo reflection, refraction or mode changes depending on the exact plume geometries, surface shapes, ultrasonic frequencies and materials. As with the apparatus of FIG. 1, the inventors realized that acoustical energies entering from one or more plumes of FIG. 2 can undergo modal changes such that within the wetted welled meniscus and water-mounds one has a complex combination of pressure waves, shear waves, and even waves induced in the work surface 2A/work article 2 itself. As with FIG. 1, the user of the apparatus of FIG. 2 may have different flow rates and/or acoustic energy regimens delivered through one or more plumes (streams) of FIG. 2. As with FIG. 1, we can tolerate some occasional gaps and defects in the plumes due to the above bridging effects on the work surface. As with FIG. 1, one may utilize continuous plumes (shown), transitory single-gapped plumes, or transitory double-gapped chunk plumes as described for FIG. 1. We note that in this FIG. 2 case of multiple plumes, one may time-stagger such transitory gaps or chunk emissions between neighboring plumes. Inventors also note that although we have mainly described continuous wave (CW) operation of the transducers we include in the scope of our invention pulsed operation, which is particularly advantageous if broadband frequencies are to be delivered, as is known in the acoustical arts.

The present inventors note that it is quite easy to establish a large standoff dimension D in FIG. 2 as compared to the film plume 3 of FIG. 1. This is because, surface tension-wise, a generally cylindrical plume 3A, 3B, 3C is less metastable than a film plume 3 of FIG. 1. The inventors include in the scope of the invention embodiments wherein the plume arrangement combines the films and streams of FIGS. 1 and 2 or the plumes alternate between shapes or dimensions.

Referring again to FIG. 2, we note that we could have alternately arranged for the separate plumes to bridge or collide with each other and co-wet into a continuous film out in front of (before workpiece arrival) the orifices (not shown). This could be done using a number of known measures, including pulsing the flow pressure and/or oscillating the individual plumes 3A-3C or their orifices. This collision region would comprise, at least in a short segment, a co-wetted merged film. Typically, though, the plumes of FIG. 2 would beneficially remain separate on average or all the time to provide large working distance D.

One may have more than one row of plumes than the one shown in FIG. 2. For example, one could have a random array of such plumes filling an area of plume emission, with the average plume-to-plume pitch to diameter approximate ratio of 3:1 (e.g., plume diameters=1, plume pitch=3, interplume gap=2). We note for any apparatus embodiment of the invention that the most general application will involve one or more plumes being somewhat curved (along their lengths) and one or more impacting plumes having an angle theta with a work surface. Of course, we include in the scope curved plumes with theta equal to zero as well as straight plumes with any theta-including zero degrees. As before, plume curvature and theta may vary with operative parameters, with gravity, with the purposeful or given ambient flow of any gaseous ambient, or with manipulation of the geometrical relationship of the wand relative to the workpiece.

We include in the scope of the invention a plume diameter d or thickness t (or any other dimension or angle) being adjustable as by user-mechanical adjustment, automatic adjustment, or substitution of parts. We also include in the scope of the invention the surrounding of one or more plumes with a flowing or static material (such as enveloping blown air) which encourages the plumes not to break down or become unstable or which favorably changes their shape or angle. In the example of blown air, one could easily intersperse (not shown) air-jets between our water plumes to accomplish this. One could also have concentric jets coaxial or collinear with the plume jet or orifice(s) (not shown). Also included in the scope of the invention is the use of catchments, shields or drains utilized to at least one of a) recycle a liquid or constituent thereof, b) prevent a liquid or constituent thereof from migrating (particularly in an airborne aerosol manner or floor-puddling manner) away from the worksite or work surface for any reason.

Additional specific processes being performed by the inventive device might, for example, also be any of the following:
a) vehicle cleaning, degreasing, deoxidation and/or polishing/sealing;
b) house or window/glazing or tile cleaning;
c) cleaning of sanitary facilities or equipments such as food processing plants, restrooms, surgical sites, meat packing plants, canning facilities;
d) cleaning or washing of buildings, walkways, roadways, signage, trains, buses, planes, ships;
e) decontamination of anything or anyone after a chemical spill or terrorist attack or exposure to a contagion, virus or bacteria;
f) standoff cleaning of high-tension electrical insulators or equipment (for this, one may employ an insulating liquid or deionized liquid);
g) cleaning of electronics, pc boards, integrated circuit wafers or chips, optical components, articles made by grinding;
h) cleaning of graffiti, soot, bird-droppings, pollen, insect larvae;
i) cleaning of oil-spills or spilled hydrocarbons from inanimate and animate objects and lifeforms;
j) elimination of the use of abrasives as in sandblasting or grit-blasting;
k) elimination of the use of ozone-depleting fluorocarbon or other solvents and gases;
l) coating, painting, priming;
m) stripping, paint removal;
n) cleaning/conditioning or coloring of fabrics, textiles, web-based materials, roll-to-roll materials, clothing (prior art ultrasonic clothes/fabric cleaners are either immersion and/or transducer-contacting);
o) firefighting (enhancement of soak-in and wetting);
p) cleaning or delousing of livestock or the fur/hides thereof;
q) presurgical cleaning or preparation of surgeons, patients or associated implements;
r) cleaning or deactivation of toxic chemicals, harmful microbes, harmful viral constituents, anthrax, botulism, Sarin, nerve gas; and
s) cleaning or wet-based processing of living entities such as plants and animals for any beneficial reason such as to kill fungus, kill bacteria, kill virus, or promote a genetic process or treatment.

In the case of a high-rise window washing application, human operators may be safety-beneficially displaced and the product may incorporate at least vertical scanning means. Transducer arrays are typically extended as described, comprising at least one row of elements or one “equivalent” row even if straight rows are not employed. Individual transducer elements may optionally be operator replaceable. Typically, an average length of a plume (whether straight or curved as by gravity or wand/surface motion) will have a length to average thickness (or diameter) ratio of 1.5:1 to 10,000 to 1, more preferably from 2.0:1 to 1,000:1, and most preferably from about 2.0:1 to 300:1. Typically, the liquid/acoustic wand array itself will have a length/width ratio between 2:1 to 1,000:1, more preferably between 5:1 to 500:1 and most preferably between 8:1 and 100:1. Typically, if multiple plumes/streams are used, their average pitch to average diameter ratio measured at the impact zone on the worksurface would be between 2:1 and 50:1, more preferably from 2.5:1 to 10:1, and most preferably between approximately 3:1 and approximately 5:1. Typically, acoustic transducer arrangements utilized will operate at at least one frequency in the KHz to a few-MHz range. Plume additives may also be utilized that favorably stabilize the plume from breakup, such as surface-tension reducers, for example. These might also do double-duty to support workpiece processing. One may also choose acoustic operating conditions that enhance the stability of the plume(s). An extended transducer array (which may be many abutted or overlapped transducers or one really long transducer) may be straight, curved, circular, polygonal, etc. Fluid effluent may be emitted from such an array at variable angles vs. time or variable angles versus position on the array. Flow rates may vary with time, with process substep, with substep progress or degree-of-completion, with acoustic emission, etc. Acoustic parameters may vary with flow and with specific orifice or specific transducer. Automatic and/or manual control of one or more of these parameters is anticipated in various embodiments. Liquids or additives dispatched from a plume may undergo phase changes such as the evaporation of a solvent or the sublimation of dry ice or supercritical CO₂ liquid.

The apparatus may be powered (at least acoustically) by an external electrical power cord, by a battery/fuel-cell pack or even by compressed gas or fluid whose forced flow causes purposeful resonation. A typical acoustic duty-cycle would have the acoustic power on a total of 25%-75% of the time allowing downtime or off-time of 75-25%, possibly for additional cooling, pulse/echo measurements, if any, or rinsing. On-time would typically comprise CW pulses, each CW pulse having multiple waveforms, typically tens of waveforms if not hundreds or thousands. Alternatively, rather than one or more fixed-frequency CW signals, one may utilize chirped or broad-band pulses alone or strung together in extended bursts.

We specifically note that, particularly in the case of CW operation, one preferably utilizes air-backed transducers (item 10 of FIG. 1) and matching layers to minimize wasted power and maximize efficiency. This is also novel to the invention.

Our liquid (more accurately “flowable”) effluent may be heated or cooled as beneficial to the work surface process, step or substep being performed. At least one of the substeps will cause a useful work surface or work-article alteration. Our acoustic pulses may be purposely asymmetric in the known manner in order to suppress cavitation if that is desired. They may alternatively be symmetric and undistorted to enhance cavitation if that is desired. One or more of our substeps may include a spray or aerosol of liquid, particularly the non-acoustic steps. Such a spray or aerosol might be powered by the same transducers and/or by other known pressurized atomizers or nebulizers. A typical spray application would be a rinse or a deposition. The apparatus may include sliders, rollers or other distance-sensors that monitor and/or maintain a desired plume length and/or angle as the workpiece translates and/or rotates relative to it.

The following definitions are put forward not as an exhaustive all-inclusive interpretation of words used, but as an aid in understanding the words as used herein.

Liquid: Any flowable material or media that can be poured, expelled or otherwise extracted under a pressure gradient, gravity, by surface-tension, capillary-action or acoustic-streaming pressures. A liquid may contain any or all of additional additive or materials such as detergents, bubbles, abrasives, ice, etc. The liquid may also contain solids in other forms of itself (ice particles, vapor bubbles). The liquid may have any number of phases and may comprise a solution, mixture, emulsion, paste, cream, gel, foam, suspension, etc. Typically, at least one substep will involve an additive or agent being placed into or used with the liquid, such as a detergent or wax.

Plume, film or stream: A volume of liquid that is substantially transportable to a workpiece from an emission orifice(s). May be continuous at a given moment (connecting the orifice and workpiece) or discontinuous at a given moment (disconnected from one or both of the orifice or workpiece). Typically, flowed by gravity and/or pressure but in some cases flowable using acoustic-streaming or capillary-action surface-tension forces.

Acoustics: Acoustic, sonic or vibratory energy which is injected or coupled into an emitted liquid plume, film or stream in any manner, at least some of which arrives at the workpiece before total attenuation occurs. Frequencies will typically be chosen in the range from 1 KHz to tens of MHz. Energy may be single frequency, multi-frequency, variable frequency, alternating frequency, broadband frequency, CW, pulsed, chirped, etc.

Bubble: Any stable or transient void or vapor bubble in a liquid, regardless of how it was formed or when it was formed. Stable oscillating bubbles can be driven with low acoustic power, whereas transient bubbles require high acoustic power. Bubbles may be in the stream and/or in the wetted or impacted film upon the work surface. Preformed bubbles may be injected or solid or gaseous nuclei typically smaller than the in-situ seeded bubbles may be employed.

Transducer: Any device that can convert a first energy type into acoustic, sonic or vibrational energy. Typically, the first energy type is electrical, electromagnetic or electrostatic energy. Transducers may be of any type including single-element, multielement, arrays, mechanically focused, acoustically lensed, mechanically unfocused, mechanically collimated, mechanically defocused, mechanically scanned, electronically scanned, etc. Multiple different transducers may be used in one or more plumes or films or two or more transducers may simultaneously be operated with different acoustic parameters.

Multi-step process: Any workpiece cleaning or treatment process wherein at least one operative parameter or constituent is changed during the total overall process-even if it is merely altered between on and off or between two fixed values. The parameter may be a liquid flow, an additive concentration, a plume shape-change (e.g., film to spray), an acoustic power, a temperature, a flow rate, etc. A typical multi-step process would be an acoustic clean followed by a rinse.

Attenuation: A measure of the time it takes for acoustic waves to decay from 90% of their initial value to 10% of their initial value. Typically, with a few exceptions, attenuation rates rise with frequency and the addition of additives including bubbles.

Water: Typically, untreated faucet or well water, treated or softened municipal water, or filtered water of any type. May be provided from domestic or industrial plumbing, from a user-reservoir or tank, from a hose, from a tanker-truck or a deionized water system. Water particularly for cleaning is beneficially treated to remove potential residues such as carbonates or particulates.

Disruptive: Altering or changing a property of an object or its surface. Used to distinguish the aggressive cleaning action of our acoustically energized liquid streams from the deliberately delicate non-disruptive acoustically energized liquids streams of the NDT prior art. We note that disruption may take place on the surface of the workpiece most commonly, but we also anticipate the ingress into the workpiece of some liquid, additive, and acoustical energy such that sub-surface regions may also be disrupted or altered. A good example of this would be the inventive disruption of a permeable material for at least several cell-dimensions distance below the exposed surface.

Target surface: The site to which the acoustically energized liquid stream is directed. The surface can include materials that are impermeable, permeable, or any combination of properties that affect the interaction of the liquid and the object that it impacts. The target surface may be below, adjacent beside or even above the device. In many applications, such as cleaning or treating permeable fabric from roll-to-roll, the wetting and cleaning action will take place through the entire fabric thickness-perhaps with some or all used liquid leaking through the fabric-despite the cleaning wand being on just one side of the fabric web.

While operating in the cavitational mode, the invention may be used, for example, for wound-cleaning or debridement. In this case, damage is actually desired to remove scab and other undesired tissue and exudates.

Further, while operating in either the cavitational or non-cavitational modes, one may utilize the apparatus to enhance the permeability of the skin or to treat burns, for example.

Both of these examples are of surface-driven processes not taught by the prior art using our type of apparatus and method.

While the invention has been described in detail with reference to preferred embodiments thereof, it will be apparent to one skilled in the art that various changes can be made, and equivalents employed, without departing from the scope of the invention. Specific examples of the invention described herein are not exclusive of other applicable structures and methods.

What is claimed is:

1. An acoustical cleaning or treatment apparatus comprising:
a means for providing at least one stream or plume of flowable medium for at least a period of time;
a source or means for delivering acoustic energy into the flowable stream or plume;
at least one such stream or plume arranged to at least temporarily bridge a gap between the apparatus and a workpiece to be cleaned or treated; and
acoustic energy passing from the apparatus to the workpiece through or along at least a portion of one such bridging stream or plume,
said acoustic energy and flowable medium impacting or flowing upon, across, or into the workpiece providing said cleaning or treatment.

2. The apparatus of claim 1 arranged to at least one of produce cavitation at the workpiece or at any point on the workpiece across, through or into which the medium flows.

3. The apparatus of claim 1 wherein the plume or stream acts as an acoustic waveguide or an acoustic conduit.

4. The apparatus of claim 1 wherein either or both of the flowable medium and the acoustic energy are delivered from one or more separate or common orifices or apertures.

5. The apparatus of claim 1 wherein the flowable stream or plume is shaped in any manner to at least one of enhance acoustic propagation or amplify an acoustic intensity.

6. The apparatus of claim 1 wherein the acoustic source is at least one transducer, transduction means, or is an acoustic output port of an acoustic waveguide or conduit.

7. The apparatus of claim 1 wherein the acoustic energy, the medium, or both is or are passed through at least one orifice or aperture situated between the acoustic source and the work piece.

8. The apparatus of claim 7 wherein measures are taken to minimize acoustic reflections in a region between any orifice or aperture and an acoustic source.

9. The apparatus of claim 1 wherein substantially most or all of the acoustic energy passes into the stream or plume with little or no reflection.

10. The apparatus of claim 1 wherein some or all flowable medium is combined, at any point, with an additive or agent that enhances any aspect of a cleaning or treating process.

11. The apparatus of claim 10 wherein the additive is at least one of a) a cavitation promotion agent, b) a cavitation suppression agent, c) a soap, detergent or wetting agent, d) an agent which reacts with a workpiece, e) a workpiece etchant or coating, and f) an abrasive material.

12. The apparatus of claim 1 wherein the acoustic source is operated with at least one frequency component for one or more waveforms or pulses.

13. The apparatus of claim 1 wherein the acoustic source is sufficiently cooled such that it can cause cavitation at or on a workpiece without itself overheating.

14. The apparatus of claim 1 wherein a plume or stream of medium at least one of:
a) has a preferred aspect ratio, size or shape for acoustical propagation reasons;
b) is elongated in a direction normal to its flow;
c) provides said bridging one or both of constantly or intermittently; and
d) contains or otherwise incorporates or carries a cleaning or treating agent dissolved or otherwise captured, entrained or suspended in the medium.

15. The apparatus of claim 1 wherein multiple plumes or streams are utilized, whether simultaneously or sequentially.

16. The apparatus of claim 1 wherein two or more plumes or streams are combined at or before arrival at or on the work piece.

17. The apparatus of claim 1 wherein at least one plume or stream wets or coats at least a portion of the workpiece with a meniscus.

18. The apparatus of claim 1 wherein any or all of the workpiece, apparatus or an emanating plume or stream are scanned, swept, translated, rotated, oscillated, vibrated or otherwise moved relative to each other during a cleaning or treating process.

19. The apparatus of claim 1 wherein a plume or stream at least one of:
a) has its flow or shape determined, at least partly, by gravity;
b) has its flow or shape determined, at least partly, by an applied pressure;
c) has its flow or shape determined, at least partly, by a gap geometry or dimension; and
d) has its flow or shape determined, at least partly, by an orientation of the workpiece, apparatus, stream or plume.

20. The apparatus of claim 1 wherein a flow or shape of a plume or stream is at least partly determined by at least one of:
a) an applied apparatus pressure or gravity;
b) a shape or size of an orifice or aperture;
c) the influence of passing acoustic energy;
d) the influence of a carried or contained agent or additive;
e) a physical manipulation of an orifice or aperture;
f) rotation or vibration of an orifice or aperture;
g) a viscosity of the flowed medium or medium plus agent;
h) a surface tension of the flowed medium or medium plus agent; and
i) a flow of a gas or vapor that impinges upon at least part of a plume or stream.

21. The apparatus of claim 1 wherein a stream or plume is utilized to carry sensing information between the workpiece and the apparatus in any direction, the sensed information relating to a workpiece, plume, stream, apparatus, medium or agent parameter.

22. The apparatus of claim 1 wherein the acoustic source comprises at least one of:
a) a single acoustic transduction element or transducer;
b) two or more acoustic transduction or transducer elements possibly activated in a phased manner;
c) one or more transduction elements or transducers achieving an acoustic focus by at least one of mechanical or electronic focusing;
d) a piezoelectric, magnetostrictive, electromagnetic or electrostatic transducer; and
e) one or more transduction elements held in an alignment with one or more orifices or apertures.

23. The apparatus of claim 1 wherein the source includes at least one acoustic transducer or transduction means having an acoustic matching layer.

24. The apparatus of claim 1 wherein one or more acoustic beams is formed in or along the volume or surface of a plume or stream.

25. The apparatus of claim 24 wherein one or more acoustic beams is steered or moved within a movable plume or stream, the movable plume or stream acting as a moving, flexing or scanning waveguide or acoustic conduit thereby also moving the beam with it.

26. The apparatus of claim 1 wherein an acoustic beam is scanned along or across a workpiece inside the confines of or on the surface of one or more flowing plumes or streams, regardless of whether the plume itself is also moved or scanned.

27. The apparatus of claim 1 wherein a plume or stream is flowed upon a workpiece with at least one of the following attributes:
a) the flow velocity allows for laminar flow;
b) the flow velocity allows for turbulent flow;
c) the flow velocity is sufficiently high to influence cavitation behavior on the work piece;
d) the flow velocity is an appreciable fraction of the acoustic sound velocity in the medium;
e) at work piece impact the plume or stream wets-out or forms a coating meniscus, at least some cleaning or treating taking place in the meniscus region; and
f) two or more impacting streams or plumes at least one of flow together or form joining meniscuses on the workpiece surface, at least some cleaning or treating taking place in the overlapping meniscus regions.

28. The apparatus of claim 1 wherein cleaning or treating takes place at or on the workpiece at a location where both flowed medium and acoustic energy each arrive at some point or points in time during the treatment.

29. The apparatus of claim 1 wherein said cleaning or treating includes at least one of:
a) removal of dirt or contamination from a workpiece or workpiece surface;
b) removal of corrosion or tarnish from a workpiece or workpiece surface;
c) removal of a toxic or biological material from a workpiece or workpiece surface;
d) stripping of a coating from a workpiece or workpiece surface;
e) etching of a workpiece or workpiece surface or a coating thereon or therein;
f) both a removal process and an additive process;
g) introduction of a cleaning or treating agent to the workpiece or to the flowable stream or plume at any location at any point in the process or process sequence;
h) formation of a conversion coating on or at the work piece; and
i) sterilization or disinfection of a work piece.

30. The apparatus of claim 1 wherein any portion of the medium, agent or additive is any of filtered, recirculated, disinfected or sterilized.

31. The apparatus of claim 1 wherein the work piece is any one or more of:
a) a mechanical, electronic or optical component or assembly;
b) a portion of a building or its glazings or windows;
c) a work piece that is normally steam-cleaned;
d) a work piece that is normally sand-blasted;
e) a public surface such as a sidewall or bathroom;
f) clothing or fabric articles to be washed or cleaned;
g) a surface from which graffiti is to be removed;
h) a medical or hospital implement or supply; and
i) a vehicle, automobile, truck, train, aircraft, bus or ship, passed under or by the operating apparatus.

32. The apparatus of claim 1 wherein the acoustic source or sources in the apparatus contribute to the formation of a movable or scannable acoustic beam directable to the worksurface through or along at least one plume or stream.

33. The apparatus of claim 1 wherein substantially all of at least one plume or stream carries acoustic energy to the workpiece either or both of: a) at a point in time, and b) over a period of time.

34. The apparatus of claim 1 wherein any of:
a) an agent or additive is predeposited on the workpiece in any manner; and
b) a plume or stream is shaped, steered or deflected using a flowed gas or air.

35. The apparatus of claim 1 wherein said bridging and said acoustical energy injection into the plume or stream are at least one of:
a) substantially simultaneous;
b) temporally overlapping; and
c) at least partially temporally non-overlapping such that acoustic energy propagates along a plume that is plume-detached from at least one of the apparatus or work piece for at least a period.

36. An acoustical cleaning or treatment apparatus comprising:
a means for providing at least one stream or plume of flowable medium for at least a period of time;
a source or means for delivering acoustic energy into the flowable stream or plume;
at least one such stream or plume arranged to at least temporarily bridge a gap between the apparatus and a workpiece to be cleaned or treated; and
acoustic energy passing from the apparatus to the workpiece through or along at least a portion of one such bridging stream or plume,
said acoustic energy and flowable medium impacting or flowing upon, across, or into the workpiece providing cavitation-aided cleaning or treatment.

37. The apparatus of claim 36 wherein said workpiece-local cavitation is acoustically driven by at least one acoustic source or means located on or in the apparatus and the cavitation energy passes through or along at least one said stream or plume to cause said workpiece-local cavitation.

38. The apparatus of claim 36 wherein cavitation action is monitored or detected in any manner supportive of the beneficial use of the apparatus.

39. The apparatus of claim 36 wherein a plume or stream is flowed with a velocity between zero and supersonic.

40. A method of acoustical cleaning or treatment comprising:
providing an acoustical cleaning or treatment apparatus comprising
a means to provide at least one stream or plume of flowable medium for at least a period of time,
a source or means to deliver acoustic energy into the flowable stream or plume,
at least one such stream or plume operated or flowed to at least temporarily bridge a gap between the apparatus and a workpiece to be cleaned or treated, and
acoustic energy being passed from the apparatus to the workpiece through or along at least a portion of one such bridging stream or plume,
said acoustic energy and flowable medium impacting or flowing upon, across, or into the workpiece providing said cleaning or treatment; and
subjecting the work piece to said acoustical cleaning or treatment.

41. The method of claim 40 wherein cavitation is caused local to, on or in the workpiece, the cavitation acoustically driven by the acoustic sources or means which is injecting acoustical energy into the arriving stream or plume.

42. The method of claim 40 wherein any of:
a) an additive or agent is utilized to enhance a cleaning or treatment;
b) relative movement or scanning of the workpiece and the apparatus is utilized;
c) scanning or movement of a plume or stream is utilized for any reason;
d) acoustical energy is guided or contained by a plume, stream or meniscus;
e) an acoustic beam is formed or steered within the confines of a plume or stream; and
f) non-immersion cavitation-aided cleaning or treating is provided.

43. A method of non-immersion cavitation-aided cleaning or treating comprising
providing an apparatus injecting acoustical energy into an emanating plume or stream of flowable medium;
providing a work piece or subject to be cleaned or treated;
directing the emanating plume or stream so as to impact or wet the work piece or subject, the plume or stream carrying acoustical energy with it; and
the impacting or wetting medium and acoustical energy providing an acoustic cavitation-supported cleaning or treating process.

44. The method of claim 43 wherein said treating is a medical therapy or surgery utilizing at least some beneficial cavitation.
